(19) United States
(12) Patent Application Publication
(10) Pub. No.: US 2021/0066999 A1
(43) Pub. Date: Mar. 4, 2021

(54) COMPACT GEAR MOTOR

(71) Applicant: BONTAZ CENTRE R & D, Marnaz (FR)

(72) Inventors: Anthony Raymond Arthur TAUPEAU, SAINT-JORIOZ (FR); Timothée BACLE, CORNIER (FR); Ali MAKKI, BORDEAUX (FR)

(21) Appl. No.: 16/958,008

(22) PCT Filed: Dec. 21, 2018
(86) PCT No.: PCT/FR2018/053531

§ 371 Date: Jun. 25, 2020

(30) Foreign Application Priority Data
Dec. 26, 2017 (FR) 1763229

(51) Int. Cl. H02K 7/116; F16H 1/46; F16H 1/28; F16H 57/02; H02K 11/215; H02K 21/16

(52) U.S. Cl. CPC H02K 7/116; F16H 1/46; F16H 1/28; F16H 2057/02034; H02K 11/215; H02K 21/16; F16H 57/02

(57) ABSTRACT

A gear motor comprises a brushless electric motor, a planetary reduction gear, and an output shaft rotationally connected to the planetary reduction gear, the electric motor comprising a stator and a rotor inside the stator. The rotor can be rotated about a longitudinal axis by the rotor. The reduction gear is housed at least partially inside the rotor and comprises at least one first sun gear, at least one first planet gear engaging with the first sun gear, and an outer ring gear inside the rotor and engaged by the first planet gear. The first sun gear and the first planet gear are driven in rotation by the rotor. The gear motor comprises a centring spindle extending along the longitudinal axis and passing through the stator and the rotor, and guiding the rotation of the rotor, the first sun gear and the first planet gear, and the output shaft.

### TECHNICAL FIELD AND STATE OF THE RELATED ART

The present invention relates to a gear motor including a brushless motor and a reduction gear, offering a compact size.

In the automotive industry, valves controlled in on/off mode or proportionally by an electric motor are used. These valves serve for example to manage the supply of coolant, fuel, oil, etc.

It is sought to use electric motors having a compact size to be suitable for integration in motor vehicles.

Moreover, it is sought to produce electric motors having a sufficient output rotational speed and a sufficient torque.

It is possible to use an electric motor offering a high output rotational speed and a low torque connected to a reduction gear at the output of the electric motor, which makes it possible to reduce the overall output speed and increase the torque.

However, the use of a reduction gear can increase the size substantially.

### DESCRIPTION OF THE INVENTION

Consequently, an aim of the present invention is that of offering a gear motor having a compact size while being capable of generating a sufficient output torque.

The aim stated above is achieved by a gear motor including a brushless motor and a planetary reduction gear integrated in the motor, such that the size of the gear motor is defined by the size of the rotor and the stator of the electric motor.

The planetary reduction gear includes a ring gear contained in the rotor, the ring gear containing the set of elements of the planetary reduction gear.

The gear motor offers a high level of integration.

The elements of the reduction gear and of the electric motor are preferably disposed such that the shaft of the electric motor is aligned with the output shaft of the gear motor.

Very advantageously, the gear motor includes a single centring shaft which centres the elements of the reduction gear in relation to the rotor, and about which the rotor and the reduction gear elements rotate. It limits the wear of the reduction gear. Furthermore, it facilitates assembly. It also makes it possible, in the case of plastic reduction gear elements, to provide sufficient play between the elements so that they mesh correctly.

Furthermore, the use of a single shaft makes it possible to reduce losses substantially, as the rotatable elements of the reduction gear rotate about this shaft of small diameter and of great length, in order to obtain a diameter/length ratio ensuring satisfactory guidance, etc.

Advantageously, all or some of the parts of the reduction gear are made of plastic. The external ring gear may be advantageously made of one piece with a part of the gear motor housing.

The electric motor is preferably a three-phase motor and the stator includes at least three coils.

The mechanical output power of the gear motor and the efficiency thereof may be set according to the perimeter of the rotor, and the torque attained is determined according to the speed reducing ratio.

One subject-matter of the present invention then is a gear motor including a brushless electric motor, a planetary reduction gear and an output shaft secured in rotation to the planetary reduction gear, said electric motor including a stator, a rotor disposed in the stator, said rotor being suitable for being rotated about a longitudinal axis by the rotor, said reduction gear being housed at least partially in the rotor, said reduction gear including at least a first sun gear, at least a first planet gear engaging said first sun gear, and an external ring gear disposed in the rotor and engaged by the first planet gear, the first sun gear and the first planet gear being rotated by the rotor. The gear motor includes a centring shaft extending along the longitudinal axis and traversing the stator, the rotor, and guiding the rotor, the first sun gear and the first planet gear and the output shaft in rotation.

In an advantageous example, the gear motor includes a casing wherein the electric motor and the planetary reduction gear are housed, said casing including a first part and a second part engaging with one another so as to confine the electric motor and the planetary reduction gear, the second part including a passage traversed by the output shaft, and the first part including a receptacle receiving a longitudinal end of the centring shaft, the other longitudinal end of the centring shaft being received in a receptacle formed in the output shaft.

For example, the ring gear is secured to the second part. Advantageously, the external ring gear is made of one piece with the second part.

For example, the first sun gear is secured in rotation to a hub driven directly by the rotor, and the first planet gear is borne by a planet gear carrier plate housed in the rotor.

In a particular example, the reduction gear includes a second sun gear secured in rotation to the first planet gear carrier plate and at least a second planet gear mechanically connected to the output shaft.

The reduction gear may include a second planet gear carrier plate bearing the second planet gear and to which the output shaft is secured in rotation.

Advantageously, the centring shaft also traverses the first planet gear carrier plate, said planet gear carrier plate being free to rotate in relation to the centring shaft.

The reduction gear may include three first planet gears and three second planet gears.

Advantageously, the first planet gear carrier plate and/or the second planet gear carrier plate, the first sun gear and/or the second sun gear and/or the first planet gear and/or the second planet gear and/or the output shaft and/or the casing is or are made of plastic.

Advantageously, the electric motor has a ratio πD/Np between 4 mm and 7.3 mm, D being the outer diameter of the rotor magnet, and Np, the number of poles of the rotor, and Np is greater than 10.

The gear motor advantageously includes an angular output shaft position sensor comprising at least one magnet secured in rotation with the output shaft and means for detecting the magnetic field of said magnet.

Another subject-matter of the present invention is a system including at least one proportional or on/off valve and a gear motor according to the invention controlling said valve.

The present invention also relates to a motor vehicle including at least one gear motor according to the invention and/or at least one system according to the invention.

### BRIEF DESCRIPTION OF THE DRAWINGS

The present invention will be understood more clearly based on the following description of the appended drawings wherein:

FIG. 1 is a side view of the gear motor according to an example of an embodiment of the present invention, the casing being represented transparently,

FIG. 2 is a perspective view of the gear motor in FIG. 1, the casing being partially represented and represented transparently,

FIG. 3A is an exploded view of the gear motor in FIG. 1,

FIG. 3B is a longitudinal sectional view of an advantageous alternative embodiment of the gear motor in FIG. 1,

FIG. 4A is a view of the driving gear motor in FIG. 1 via the cover,

FIG. 4B is a top view of the stator and the rotor mounted on the electronic board.

### DETAILED DESCRIPTION OF PARTICULAR EMBODIMENTS

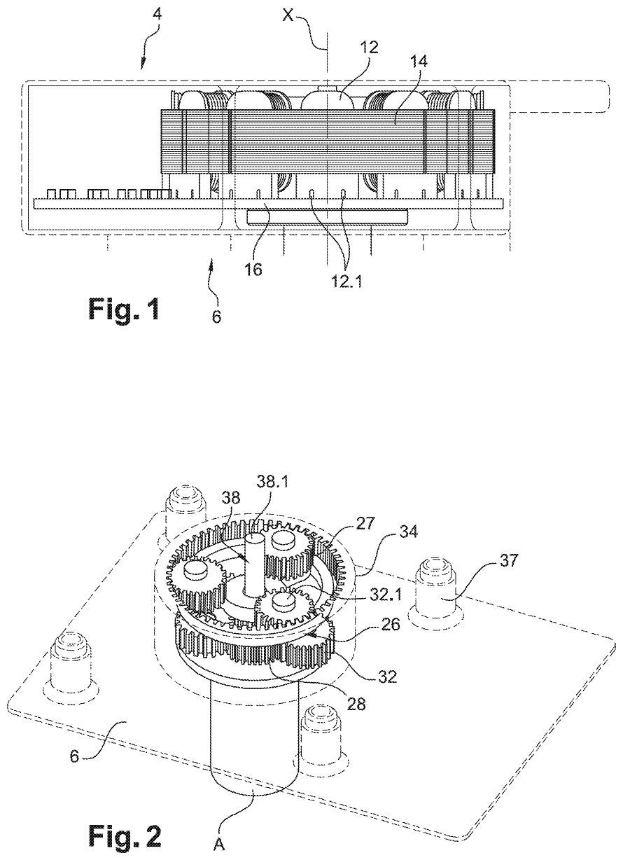

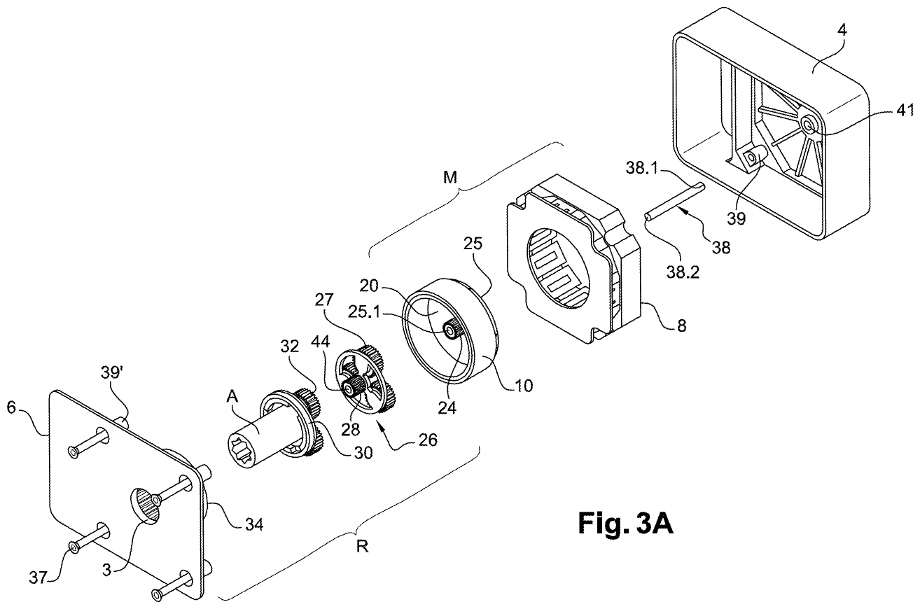

In FIGS. 1 and 2, an example of the gear motor according to the invention can be viewed externally.

The gear motor extends along a longitudinal axis X. It includes a casing 2 wherein the electric motor M and the planetary reduction gear R are housed. The casing 2 protects the motor and the reduction gear from the external environment. The gear motor includes at a longitudinal end an output shaft A projecting out of the casing 2 via an opening 3.

Hereinafter in the description, the longitudinal end of the gear motor including the output shaft A will be referred to as “downstream end”, the other longitudinal end of the gear motor will be referred to as “upstream end”. The orientation of the different elements of the gear motor in relation to these ends may be referenced using the term “upstream” or “downstream”.

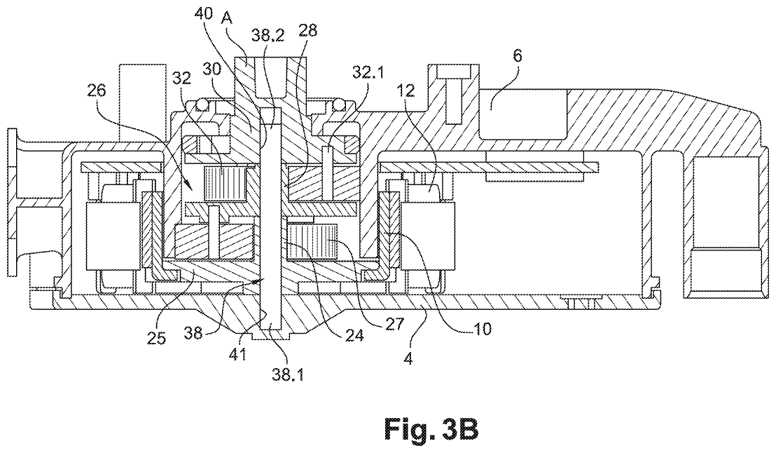

In FIG. 3A, an exploded view of the gear motor can be seen, along the axis X and in FIG. 3B, a longitudinal sectional view of an alternative embodiment of the gear motor in FIG. 1, very similar to the gear motor in FIG. 1, can be seen.

The casing 2 includes a housing 4 and a cover 6 closing the housing.

The electric motor is a brushless motor, includes a stator 8, a rotor 10 disposed in the stator 8 and an electronic board 16.

The stator 8 includes coils 12 housed in a stack of sheets 14. The stator has a structure well-known to those skilled in the art. Preferably, the electric motor is a three-phase motor including a number of coils 12 that is a multiple of three distributed angularly regularly about the axis X.

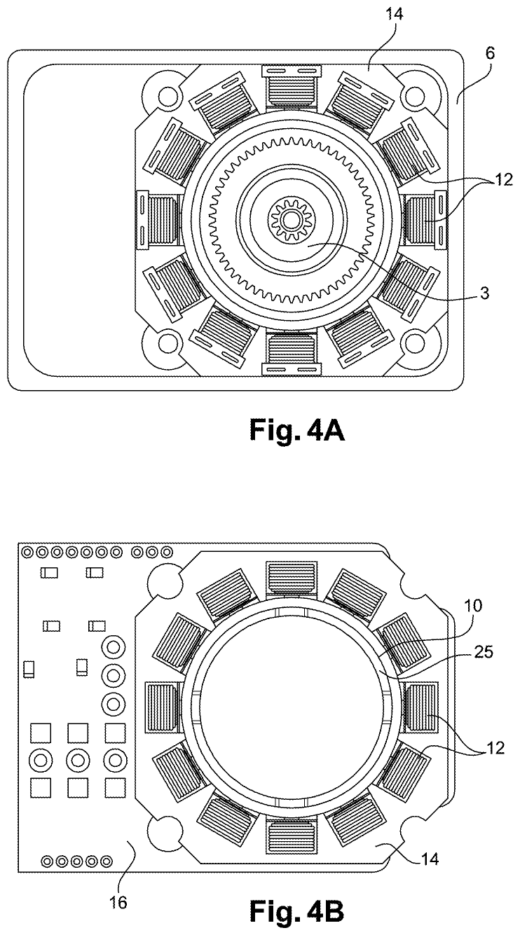

In FIG. 4A, a top view of the stator 8 can be seen. In FIG. 4B, the stator 8 is mounted on the electronic board 16 whereon the pins 12.1 of the coils are connected, for example by welding or by press-fitting, and which serves to control the rotor.

The rotor 10 is mounted inside the stator. It has the shape of a sleeve and is intended to rotate in the stator about the axis X. The rotor is formed from a permanent magnet including several pole pairs, for example from 4 to 40 pole pairs. The rotor 10 is rotated about the axis X by the magnetic field generated by the current passing through the stator 8 winding.

The reduction gear R includes a hub 20 secured in rotation to the rotor 8 about the axis X. In the example represented, the hub has the shape of a disk provided with four lugs 22 projecting radially outward and engaging with notches 23 formed in a cylinder head 25 of the rotor, fastened to an upstream axial end of the rotor 10, ensuring the rigid connection in rotation of the rotor 10 and the hub 20. The rigid connection in rotation of the rotor and the hub can be carried out by other means, for example by mechanical crimping of the cylinder head 25 with the hub 20, or by rigidly connecting the hub 20 directly by over-moulding about the cylinder head 25.

The hub 20 includes a downstream face opposite that oriented towards the housing a pinion 24 forming a first sun gear of the reduction gear R. The first sun gear 24 is therefore rotated directly by the hub 20.

The reduction gear also includes a first planet gear carrier plate 26 and three first planet gears 27 rotatably mounted on an upstream face of the planet gear plate 26 about shafts parallel with the axis X. The first planet gears 27 engage the first sun gear 24. A second sun gear 28 is secured in rotation with the first planet gear carrier plate 26 and is disposed on the axis X on a downstream face of the first planet gear carrier plate 26, opposite the upstream face bearing the first planet gears 27.

The reduction gear includes a second planet gear carrier plate 30 and three second planet gears 32 rotatably mounted on an upstream face of the second planet gear plate 30 about shafts 32.1 (FIG. 2) parallel with the axis X. The second sun gear 28 engages the second planet gears 32.

Advantageously, the planet gears 27 and 32 are identical, which makes it possible to simplify the manufacture of the gear motor.

The output shaft A of the gear motor is secured in rotation with the second planet gear carrier plate 30 and projects out of a downstream face of the second plate 30 opposite the upstream face bearing the second planet gears 32. In the example shown, the output shaft A includes at the downstream end thereof a star-shaped hollow cavity 33 for a connection to an external gear motor to be driven. The downstream end of the output shaft may have other shapes according to the type of connection required. The output shaft A may be guided in rotation by the outline of the opening 3 formed in the cover.

The reduction gear also includes an external ring gear 34 of axis X, disposed inside the rotor 10 and outside the first 27 and second 32 planet gears, such that the planet gears 27 and 32 engage the ring gear 34. All the elements of the reduction gear are therefore disposed inside the ring gear 34. The ring gear 34 is fixed in relation to the casing.

Very advantageously, the ring gear 34 is made of one piece with the cover, for example by moulding. Alternatively, the ring gear 34 is fastened to the cover 6 by bonding, by screws, etc.

Very advantageously, a single centring shaft 38 passes through the reduction gear R and the motor M and centres the different elements of the reduction gear and the rotor 10 in relation to the stator 8. The cylinder head 25 includes a central passage 25.1 traversing the first sun gear enabling the passage of the centring shaft 38. The air-gap between the rotor 10 and the stator 8 is thus fixed without using a bearing. Removing the bearings helps extend the service life of the gear motor. Furthermore, the embodiment of the gear motor is simplified, and the mass thereof is reduced.

The centring shaft 38 is held axially and transversally in the gear motor. For this, the inner base of the housing includes a receptable 41 receiving a longitudinal end 38.1 of the shaft 38, and the second planet gear carrier plate 30 also includes a receptacle 41 between the second planet gears on the upstream face thereof receiving the other end of the shaft 38. The second planet gear plate 30 being guided by the outline of the opening in the cover 6 via the output shaft A, the other end of the centring shaft 38 is also held axially and transversally. The shaft 38 is fixedly mounted in the housing 4, for example the end 38.1 is press-fitted in the receptacle 41 of the housing 4.

Furthermore, the first sun gear 24 and the second sun gear 28 include at the centre thereof an axial passage 42, 44 respectively, for the passage of the centring shaft 38. The diameters of the receptacles 40, 41 and of the receptacles 42, 44 are adjusted to the diameter of the shaft 38, in order to ensure a transversal hold of the centring shaft 34 and satisfactory guidance of the different elements of the reduction gear.

The shaft 38 carries out the guidance, recentring of all the movable elements and also fulfills the function of sliding bearing for movable elements.

The centring shaft 38 is advantageously made of metal, for example of steel, advantageously of stainless steel to have a sufficient rigidity. The diameter of the shaft may be set precisely using a grinding operation. Advantageously, the shaft 38 is produced with high precision, for example by machining. The diameter thereof advantageously has a maximum tolerance of 20 μm and a cylindricity of 5 μm.

The plays between the shaft 38 which is fixed in the casing and the movable elements are advantageously between 20 μm and 60 μm.

The housing and the cover are disposed such that the receptacles 40 and 41 ensure coaxiality between the centring shaft 38 and the ring gear 34.

The use of the fixed centring shaft and the positioning precision, which may be obtained when producing the housing and the cover integrating the ring gear 34 and during the assembly thereof, makes it possible very advantageously not to use ball bearings between the centring shaft and the elements rotatable about same.

The use of this centring shaft 38 makes it possible to limit the wear of the reduction gear. Furthermore, it facilitates assembly. It also makes it possible, in the case of plastic reduction gear elements, to provide sufficient play between the elements so that they mesh correctly.

Advantageously, the shafts of the planet gears on the planet gear carrier plates are made of steel, for example of stainless steel, to enhance the guidance even further and prevent wear of the gear teeth of the planetary reduction gear (FIG. 3B).

Furthermore, the use of a single shaft makes it possible to reduce losses substantially, as the rotatable elements of the reduction gear rotate about this shaft of small diameter.

It will be understood that it is possible to modify the order of the elements of the reduction gear. Indeed, it is possible to envisage that the hub forms a planet gear holder, which engages a sun gear borne by a planet gear carrier plate, then driving second planet gears which engage a second sun gear secured in rotation to the output shaft. In this configuration, the first planet gear carrier plate 26 may be turned over, the upstream face forming the downstream face.

Advantageously, the cover and the ring gear 34 are made of a plastic material.

The cover 6 is fastened to the housing for example with screws 37. Any other rigid connection means may be envisaged, even a definitive means. When the shapes are suitable, the cover and the housing may be screwed onto one another, a seal is then provided to protect the inside of the gear motor from external damage.

Advantageously, the cover and the housing are secured by welding, for example ultrasonic directly rendering the board leak-tight.

Very advantageously, in order to prevent an increase in the pressure in the gear motor due to the overheating caused by the operation of the gear motor, means (not shown) are provided to discharge the excess pressure. For example, it consists of an opening, for example in the form of a grid, in the cover or the housing, sealed with an air-permeable membrane and preventing the liquid from entering the gear motor, for example made of Goretex®. The membrane is for example welded ultrasonically.

Advantageously, the outer outline of the stator 8 is shaped to engage with the screw passages 39 formed in the base of the housing 4 and in the cover 6, which holds the stator 8 in position in the casing. The outer outline of the stator 8 includes notches of dimensions suitable for housing the screw passages 38. Further holding means may be envisaged, for example the stator may be fastened to the cover or the housing.

Very advantageously, all or some of the parts of the reduction gear are made of plastic, by moulding and/or by machining. The first planet gear carrier plate 26 and the second sun gear 28 may be made of one piece by moulding. The second planet gear carrier plate 30 and the shaft A may also be made of one piece by moulding.

Preferably, the sun gears 24, 28, the planet gears 27, 32 and the external ring gear 34 are made of plastic. The shafts about which the planet gears are rotatably mounted are also advantageously made of one piece by moulding with the planet gear carrier plates.

As explained above, very advantageously, the shafts of the planet gears may be made of steel, for example of stainless steel or of any material offering satisfactory rigidity, for example assembled with the planet gear holder by over-moulding or by press-fitting.

The planet gears are for example locked onto the shaft thereof.

Thanks to the invention, the height of the reduction gear is substantially equal to that of the electric motor. Thus, the size, both axial and transversal, of the gear motor is substantially reduced.

It will be understood that the reduction gear may include more at least than three planet gears 27 and more at least than three planet gears 32, for example 1, 3, 4, 5 . . . , the number of stages being chosen according to the kinematic equilibrium sought and the speed involved.

The housing 4 and the cover 6 may be inverted, the ring gear 34 then being secured to the base of the housing 4.

Alternatively, the casing including two substantially symmetrical parts, including a base and side wall, the height whereof is substantially equal to the total half-height of the casing. In the example shown, the motor shaft and the output shaft A are aligned.

Alternatively, the ring gear 34 may include different inner diameters, for the planet gears 27 and 32 according to the selected speed reducing ratio, and/or the external ring gear 34 may include several superimposed parts along the axis X.

Also alternatively, the planet gears 27 and/or 32 may have double gear teeth, gear teeth engaged by the sun gear and gear teeth engaging the ring gear.

Furthermore, the reduction gear may only include a single stage or more than two stages according to the output torque sought.

Advantageously, the gear motor includes an angular position sensor of the output shaft A for example helping establish on-board diagnostics (OBC), making it possible to have a motor control feedback loop carried out by a motor control unit, advantageously integrated in the gear motor. For example, the sensor includes a magnet, for example of 1 to 4 poles integrated in the output shaft, advantageously during the moulding of the shaft. The passage of the magnet is detected by an element sensitive to the magnetic field of the magnet mounted for example on the cover or mounted on the electronic motor control board. In the example shown, the magnet is borne by the planet gear holder 30.

The mechanical output power of the gear motor and the efficiency thereof may be set according to the perimeter of the rotor, and the torque attained is determined according to the speed reducing ratio.

Very advantageously, the motor has a polar arc which is defined as the ratio πD/Np between 4 mm and 7.3 mm, where D is the outer diameter of the magnet, and Np the number of poles of the magnet, Np being greater than 10.

The invention makes it possible to produce a compact gear motor, for example thanks to the reduction gear in FIGS. 1 to 3A, the gear motor may be contained in a shell of 60 mm in height and of cross-section 54 mm×54 mm, 54×54 being the dimensions of the stator, accounting for play, the casing has a cross-section of 60 mm×60 mm or 62 mm×62 mm, and offer an output torque between 0 N and 0.5 N, or attain 4 N.m according to the supply conditions, according to the speed reducing ratio, and an output shaft speed between 0 rpm and 30 rpm.

Furthermore, the gear motor according to the invention has a substantial service life, on one hand, thanks to the use of a brushless motor, and, on the other, thanks to the centring shaft which limits the wear of the reduction gear elements.

The gear motor according to the invention further has the advantage of offering a simplified assembly and also a simplified disassembly.

For example, the stator 8 is mounted around the ring gear 34. Then, the reduction gear is assembled by mounting for example one end of the centring shaft in the planet gear holder 30 and then by assembling the planet gear holder 26 bearing the planet gears 27; then the rotor. The housing is finally positioned and is secured to the cover 6 by the screws 37, and/or by ultrasonic welding. The end 38.1 is inserted by force into the receptacle 40 of the housing 4.

The gear motor according to the invention is applicable for driving any type of device, in particular onboard devices due to the very compact size of the gear motor according to the invention. It is particularly suitable for controlling valves for managing the flow of fluids in a motor vehicle, for example water, exhaust gases, coolant, oil, fuel, brake fluid, windscreen washer fluid. It furthermore enables on/off or proportional control of the valves.

The gear motor according to the invention may be used in a system requiring rotational drive, such as for example a window-lift motor, in a pump, for example an oil pump, a water pump, etc., or any other electric pump.

1-14. (canceled)

15. Gear motor comprising a brushless electric motor, a planetary reduction gear and an output shaft secured in rotation to the planetary reduction gear, said electric motor including a stator, a rotor disposed in the stator, said rotor being suitable for being rotated about a longitudinal axis by the rotor, said reduction gear being housed at least partially in the rotor, said reduction gear including at least a first sun gear, at least a first planet gear engaging said first sun gear, and an external ring gear disposed in the rotor and engaged by the first planet gear, the first sun gear and the first planet gear being rotated by the rotor, wherein said gear motor includes a centring shaft extending along the longitudinal axis and traversing the stator, the rotor, the centring shaft being mounted directly in the rotor, the output shaft and at least the first sun gear so as to guide the rotation of the rotor, the first sun gear and the first planet gear and the output shaft, the rotor being free to rotate in relation to the centring shaft, the gear motor also including a casing wherein the electric motor and the planetary reduction gear are housed, said casing including a first part and a second part engaging with one another so as to confine the electric motor and the planetary reduction gear, the second part including a passage traversed by the output shaft, and the first part including a receptacle receiving a longitudinal end of the centring shaft, the other longitudinal end of the centring shaft being received in a receptacle formed in the output shaft.

16. Gear motor according to claim 15, wherein the centring shaft is fixedly mounted in the receptacle of the first part of the casing.

17. Gear motor according to claim 16, wherein the external ring gear is secured to the second part.

18. Gear motor according to claim 17, wherein the external ring gear is made of one piece with the second part.

19. Gear motor according to claim 15, wherein the first sun gear is secured in rotation to a hub driven directly by the rotor, and the first planet gear is borne by a planet gear carrier plate housed in the rotor.

20. Gear motor according to claim 19, wherein the reduction gear includes a second sun gear secured in rotation to the first planet gear carrier plate and at least a second planet gear mechanically connected to the output shaft.

21. Gear motor according to claim 20, wherein the reduction gear includes a second planet gear carrier plate bearing the second planet gear and to which the output shaft is secured in rotation.

22. Gear motor according to claim 21, wherein the centring shaft also traverses the first planet gear carrier plate, said planet gear carrier plate being free to rotate in relation to the centring shaft.

23. Gear motor according to claim 21, wherein the reduction gear includes three first pinion carriers and three second pinion carriers.

24. Gear motor according to claim 15, wherein the first planet gear carrier plate and/or the second planet gear carrier plate, the first sun gear and/or the second sun gear and/or the first planet gear and/or the second planet gear and/or the output shaft and/or the casing is or are made of plastic.

25. Gear motor according to claim 15, wherein the electric motor has a ratio πD/Np between 4 mm and 7.3 mm, D being the outer diameter of the rotor magnet, and Np, the number of poles of the rotor, and wherein Np is greater than 10.

26. Gear motor according to claim 15, including an angular output shaft position sensor comprising at least one magnet secured in rotation with the output shaft and means for detecting the magnetic field of said magnet.

27. System including at least one proportional or on/off value and a gear motor according to claim 15 controlling said valve.

28. Motor vehicle including at least one gear motor according to claim 15.

29. Motor vehicle including at least one system according to claim 27.
